(19) United States
(12) Patent Application Publication
(10) Pub. No.: US 2004/0068545 A1
(43) Pub. Date: Apr. 8, 2004

(54) Displaying and working with email attachments

(75) Inventors: W. Todd Daniell, Marietta, GA (US); Mary S. Arnoff, Lawrenceville, GA (US); Dale W. Malik, Dunwoody, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BellSouth Intellectual Property Corporation, Wilmington, DE

(21) Appl. No.: 10/326,250

(22) Filed: Dec. 19, 2002

Related U.S. Application Data
(60) Provisional application No. 60/416,916, filed on Oct. 8, 2002.
(60) Provisional application No. 60/426,422, filed on Nov. 14, 2002.

(51) Int. Cl. G06F 15/16

(52) U.S. Cl. 709/206

(57) ABSTRACT

Preferred embodiments of the present invention provide systems and methods for organizing and managing attachments from electronic messages. One embodiment of the system, among others, includes an electronic messaging client for receiving electronic messages and an attachment management system configured to preorganize default directory locations for saving attachments into those directory locations and also to display descriptive information regarding attachments such as name, type, and size. Other systems and methods are also provided.

### CROSS-REFERENCE TO RELATED APPLICATIONS

This application claims priority to copending U.S. provisional applications entitled, “FUNCTIONAL SPECIFICATION FOR E-MAIL CLIENT,” having serial No. 60/416,916, filed Oct. 8, 2002, which is entirely incorporated herein by reference; and “DISPLAYING AND WORKING WITH EMAIL ATTACHMENTS,” having serial No. 60/426,422, filed Nov. 14, 2002, which is entirely incorporated herein by reference.

### TECHNICAL FIELD

The present invention is generally related to electronic messaging, and more particularly, is related to attachments for electronic messaging.

### BACKGROUND OF THE INVENTION

Electronic messaging involves the transmission of electronic messages over computer networks, such as a local area network or the Internet. An electronic message may be a simple text message containing only ASCII, or it may be a complex message containing electronic files such as images, sounds, spreadsheets, etc. Electronic messaging is generally referred to as email, but it may also comprise other messaging technologies like instant messaging.

To send and receive electronic messages, electronic messaging clients are used. No matter which type of client is used, an electronic messaging client generally does at least the following tasks. It shows a list of all the messages in a user's mailbox by displaying information from message headers. The message header information often shows a user the address of each person who sent each message, the subject of each message, the time and date of each message, and the size of each message. The electronic messaging client also lets a user select a message header and read the body of the electronic message for that message header. Further, an electronic messaging client enables a user to create new messages and send them. In composing a message, a user typically types in the email address of the recipient and the subject for the message, and then types the body of the message. Additionally, most clients permit a user to add attachments to messages that the user sends and to also save attachments from the messages the user receives.

Specifically, an attachment is an electronic file that can accompany an electronic mail message. The attachment can be of any file format, such as word processing documents, spreadsheets, sound files, images, and other pieces of software. The attachment is often not text, but binary code. Otherwise, the attachment text could simply be added in the body of the message by the user creating the message. Accordingly, the original binary file structure of the attachment is often converted by an electronic messaging client into a file version that only contains text characters so that the file may be transmitted over messaging systems that utilize the SMTP (simple mail transfer protocol) standard, such as the Internet.

Two popular encoding mechanisms utilized by electronic messaging clients for attachments are MIME (Multipurpose Internet Mail Extension) and Uuencode. These encoding mechanisms utilize an algorithm to convert a binary file into ASCII code (text). In converting a binary file into text, the electronic messaging client delineates the beginning and end of the converted file structure with boundary markers. Between these boundary markers are also a series of headers that define the content of the attachment. A typical header clearly identifies the attachment file type, original filename, and encoding mechanism for the converted binary file. In addition, headers separate several individual attachments in an electronic message that contains multiple attachments. Also, at the beginning of each electronic message, a header indicates the email addresses of both the sender and recipient and the subject of the message.

After an electronic mail with an attachment is received by an electronic messaging client, the electronic messaging recognizes the type of attachment encoding and converts the attached file back to its binary form. To access this binary file, the recipient needs an application installed on the recipient's computer that can execute or access that particular type of file. Often, in a Windows environment, the application that is needed to execute the binary file is already associated with the filename extension of the binary file, so that a user's command to open the binary file will cause the application to access the binary file.

Generally, electronic messaging clients display and manage attachments in the same manner. For example, to access an attachment in a received email message, a user typically has to know a) that a button or icon needs to be selected; b) which particular button or icon has to be selected from a row of numerous buttons/icons; and c) numerous other steps involved in opening the attachment file. While these traditional methods may be adequate for knowledgeable or experienced users of electronic mail clients or programs, a more straight forward and less arcane management structure is desired. Thus, a heretofore unaddressed need exists in the industry to address the aforementioned deficiencies and inadequacies.

### SUMMARY OF THE INVENTION

Preferred embodiments of the present invention provide systems and methods for organizing and managing attachments from electronic messages. Briefly described one embodiment of the system, among others, includes an electronic messaging client for receiving electronic messages and an attachment management system configured to preorganize default directory locations for saving attachments to and also to display descriptive information regarding the attachment such as the name, type, and size.

The preferred embodiments of the present invention can also be viewed as providing a method for organizing and managing attachments from electronic messages. In this regard, one embodiment of such a method, among others, can be broadly summarized by the following steps: preorganizing a default directory location for storing a particular classification of attachments; receiving an electronic message having an attachment; storing the attachment in a default directory location according to the classification of the attachment; and displaying descriptive information regarding the attachment.

Other systems, methods, features, and advantages of the present invention will be or become apparent to one with skill in the art upon examination of the following drawings and detailed description. It is intended that all such additional systems, methods, features, and advantages be included within this description, and the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a computer than can implement the attachment management system of one preferred embodiment of the present invention.

FIG. 2 is a flowchart illustrating the functionality of a representative embodiment of the attachment management system of FIG. 1.

FIG. 3 is a flowchart describing the process of adding a file as an attachment as referenced in FIG. 2.

FIG. 4 is a flowchart describing the process of displaying information regarding an attachment as referenced in FIG. 3.

FIG. 5 is a flowchart describing the process of removing an attachment as referenced in FIG. 3.

FIG. 6 is a flowchart describing the process of opening an attachment as referenced in FIG. 3.

FIG. 7 is a flowchart describing the functionality of a representative embodiment of the attachment management system of FIG. 1 for displaying information regarding an attachment from an unopened electronic message.

FIG. 8 is a flowchart describing the functionality of a representative embodiment of the attachment management system of FIG. 1 for managing and displaying information regarding an attachment from an electronic message.

FIG. 9 is a flowchart describing the process of displaying information regarding an attachment in preview mode as referenced in FIG. 8.

FIG. 10 is a flowchart describing the process of displaying information regarding an attachment in an opened electronic message as referenced in FIG. 8.

FIG. 11 is a flowchart describing the process of saving an attachment as referenced in FIG. 8

FIG. 12 is a flowchart describing the process of opening an attachment as referenced in FIG. 8.

FIG. 13 is a pictorial representation of an inbox interface for one preferred embodiment of the attachment management system of FIG. 1.

FIG. 14 is a pictorial representation of an options interface of one preferred embodiment of the attachment management system of FIG. 1.

FIG. 15 is a pictorial representation of a write interface of one preferred embodiment of the attachment management system of FIG. 1.

FIG. 16 is a pictorial representation of an attachment interface of one preferred embodiment of the attachment management system of FIG. 1.

FIG. 17 is a pictorial representation of a read interface of one preferred embodiment of the attachment management system of FIG. 1.

### DETAILED DESCRIPTION OF THE PREFERRED EMBODIMENTS

The preferred embodiments of the present invention are directed to integrating the functionality of an attachment management system into an electronic messaging client such that the functionality is available to a user while the user is reading and writing an electronic message on the electronic messaging client. In one preferred embodiment, an improved system and method is provided for managing attachments in electronic messages. Generally described, this embodiment employs a graphical user interface (GUI) architecture to provide the functionality of an attachment management system within an electronic messaging client. A user can invoke the attachment management system and access the attachment management system functionality within the context of the electronic messaging client user interface. Referring now to the drawings in which like numerals represent like elements through out the several figures, aspects of preferred embodiments of the present invention will be described.

### Preferred Environment

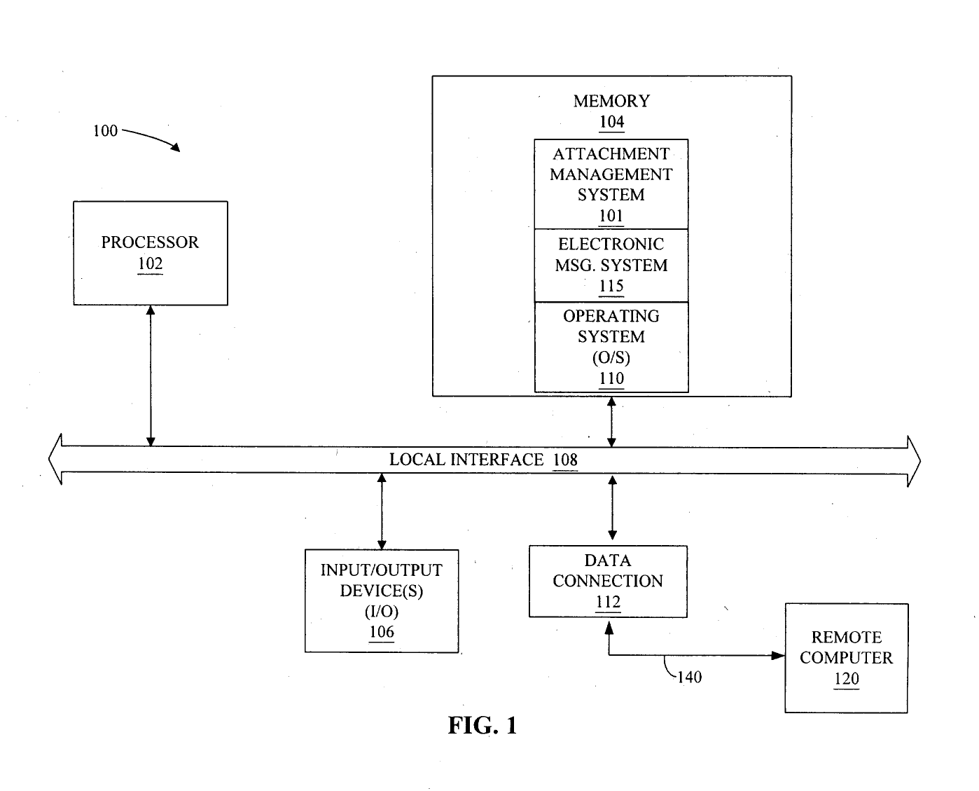

One preferred embodiment of an attachment management system of the present invention can be implemented in software, firmware, hardware, or a combination thereof. Preferably, the attachment management system is implemented in software, as an executable program in combination with other program modules, and is executed as part of an electronic messaging client by a special or general purpose digital computer, such as a personal computer, workstation, minicomputer, or mainframe computer. An example of a general purpose computer 100 that can implement the attachment management system 101 of the preferred embodiment of the present invention is shown in FIG. 1.

Generally, in terms of hardware architecture, as shown in FIG. 1, the computer 100 includes a processor 102, memory 104, and one or more input and/or output (I/O) devices 106 (or peripherals) that are communicatively coupled via a local interface 108. The local interface 108 can be, for example but not limited to, one or more buses or other wired or wireless connections, as is known in the art. Further, the local interface 108 may have additional elements, which are omitted for simplicity, such as controllers, buffers (caches), drivers, repeaters, and receivers, to enable communications. Further, the local interface may include address, control, and/or data connections 112 to enable appropriate communications among the aforementioned components.

The processor 102 may be a hardware device for executing software that can be stored memory 104. The processor 102 can be any custom made or commercially available processor, a central processing unit (CPU) or auxiliary processor among several processors associated with a computer 100, and a semiconductor based microprocessor (in the form of a microchip) or a macroprocessor.

The memory 104 can include any one or combination of volatile memory elements (e.g., random access memory (RAM, such as DRAM, SRAM, etc.)) and nonvolatile memory elements (e.g., ROM, hard drive tape, CDROM, etc.). Moreover, the memory 104 may incorporate electronic, magnetic, optical, and/or other types of storage media. Note that the memory 104 can have a distributed architecture, where various components are situated remote from one another, but can be accessed by the processor 102.

The software in memory 104 may include one or more separate programs each of which comprises an ordered listing of executable instructions for implementing logical functions. In the example of FIG. 1, the software in memory 104 includes the attachment management system 101, electronic messaging client 115, and an operating system (0/S) 110. The operating system 110 essentially controls the execution of other computer programs, and provides scheduling, input-output control, file and data management, memory management, and communication control and related services. The electronic messaging client 115 facilitates the transmission and reception of electronic messages, such as email and instant messaging. Preferably, the attachment management system 101 is integrated into or operates along with the electronic messaging client 115.

The attachment management system 101 may be a source program, executable program (object code), script, or any entity comprising a set of instructions to be performed. If the attachment management system 101 is a source program, then the program needs to be translated via a compiler, assembler, interpreter, or the like, which may or may not be included within the memory 104, so as to operate properly in connection with the O/S 110. Furthermore, the attachment management system 101 can be written as (a) an object oriented programming language, which has classes of data and methods, or (b) a procedure programming language, which has routines, subroutines, and/or functions, for example but not limited to, C, C++, Pascal, Basic, Fortran, Cobal, Perl, Java, and Ada. In addition, the attachment management system 101, in some embodiments, is so integrated into the electronic messaging client 115 that there are not clear lines of separation, as might otherwise be suggested by the present disclosure.

The I/O devices 106 may include input devices, for example but not limited to, a keyboard, mouse, scanner, digital camera, multi-function device, microphone, etc. Furthermore, the I/O devices 106 may also include output devices, for example but not limited to, a printer, display, etc. Finally, the I/O devices 106 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 100 is a PC, workstation, or the like, the software in the memory 104 may further include a basic input output system (BIOS) (omitted for simplicity). The BIOS is a set of essential software routines that initialize and test hardware at startup, start the O/S 110, and support the transfer of data among the hardware devices. The BIOS is stored in ROM so that the BIOS can be executed when the computer 100 is activated.

When the computer 100 is in operation, the processor 102 is configured to execute software stored within the memory 104, to communicate data to and from the memory 104, and to generally control operations of the computer 100 pursuant to the software. The attachment management system 101, the electronic messaging client 115, and the O/S 110, in whole or in part, but typically the latter, are read by the processor 102, perhaps buffered within the processor 102, and then executed.

The computer 100 may operate in a networked environment using logical connections to one or more remote computers, such as a remote computer 120. The remote computer 120 may be a server, a router, a peer device or other common network node, and typically includes many or all of the elements described relative to the computer 100. The data connection 112 depicted in FIG. 1 may include a dial-up modem, network interface card, DSL modem, etc. that provides access to a messaging network 140, such as the Internet.

When the attachment management system 101 and electronic messaging client 115 are implemented in software, as is shown in FIG. 1, it should be noted that the attachment management system 101 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The attachment management system 101 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the attachment management system 101 is implemented in hardware, the attachment management system 101 can be implemented with any combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

### Preferred Operation

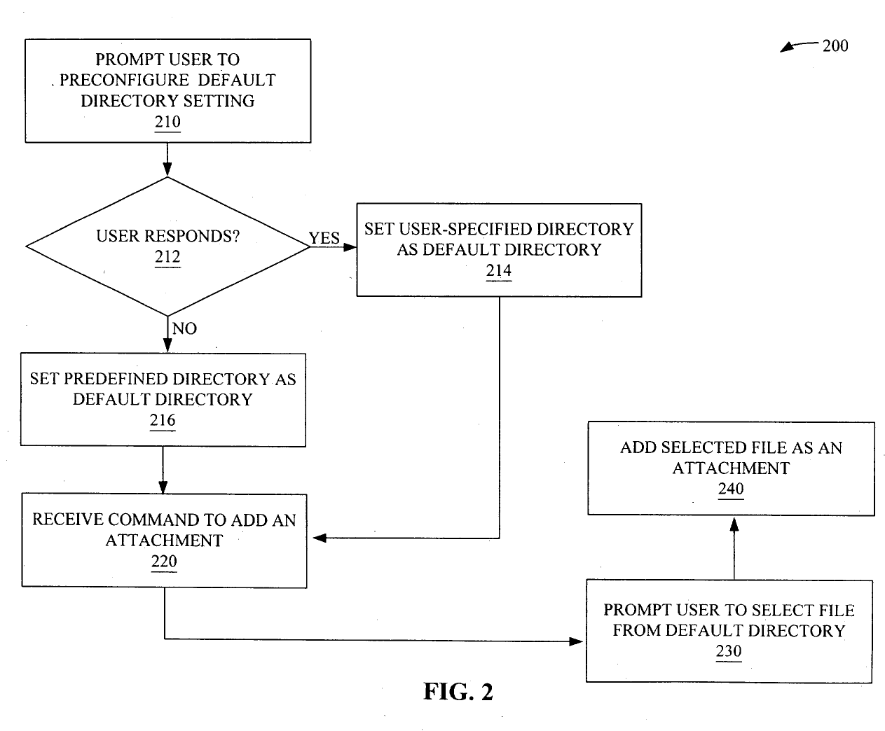

The overall operation of the attachment management system 101 will be described with reference to FIG. 2 which depicts the functionality of one preferred embodiment of the attachment management system 101. It should also be noted that in some alternative implementations the functions noted in the various blocks may occur out of the order depicted in the flowcharts of FIG. 2 and subsequent flowcharts. For example, two blocks shown in succession in a flowchart may, in fact, be executed substantially concurrently. Alternatively, the blocks may sometimes be executed in the reverse order depending upon the functionality involved.

As depicted in FIG. 2, the functionality of one preferred embodiment of the attachment managing system 101 or method 200 for adding an attachment to an electronic message may be construed as beginning at block 210. In block 210, a user is prompted to preconfigure a default attachment directory. The default attachment directory is intended to be the directory where files that are to be added as attachments are stored. Accordingly, a user is prompted to provide a customized directory name and the associated directory path for this location.

If the user provides a customized attachment directory location, as shown in blocks 212-214, then the customized attachment directory name is set as the default directory. For example, a user may specify that his or her customized file directory, “My Files for Attachments,” should be set as the default attachment directory on the C: drive of his or her computer, or some other storage medium. If the customized directory location does not exist, it will be created for the user. Alternatively, if the attachment directory location is not provided by a user, then a predefined file directory location is set as the default directory, as shown in block 216. For example, a standard directory named “My Attachments” located at C:\Attachments may be assigned as the default attachment directory settings for any user that does not specify a custom directory location. Generally, a user is also afforded the opportunity to reconfigure the default directory locations at a later time by utilizing an “option” window on a GUI of the attachment management system 101.

Next in block 220, a command is received from a user, typically via a GUI, to add a file as an attachment to an electronic message that the user is composing. Once the command is received, the user is prompted to select a file contained in the default directory location, as depicted in block 230. For example, the electronic messaging client may open a Windows Explorer file browser at the default directory location for the user to select file(s) to attach to an email message. In block 240, the selected file is added as an attachment to the electronic message.

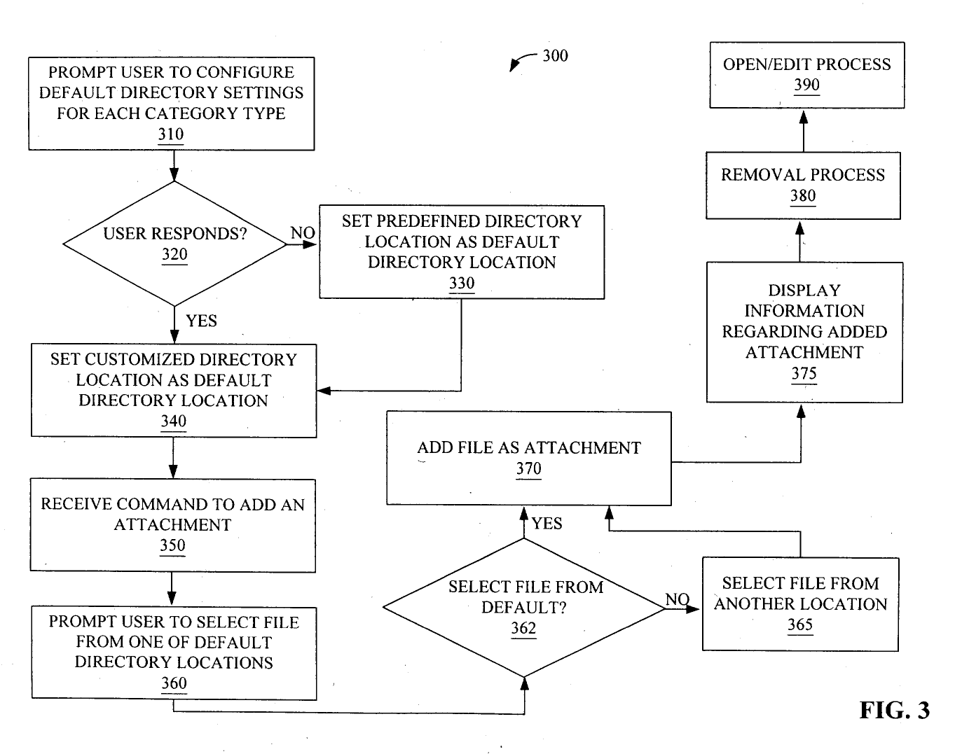

Referring to FIG. 3, one embodiment of the attachment management system 101 for adding an attachment is described in greater detail. In block 310, a user is prompted to specify the default attachment directory location for different categories of files. For example, the user may specify different attachment default directories for different classifications of files such as “sound” files, “image” files, or “general” files. A general file, as the name suggests, is a general category of files that do not fit into another type.

As depicted in block 320, the attachment management system 101 contemplates that a user may fail to provide his or her own default location. Accordingly, in block 330, if the user does not provide a particular default attachment directory location for a file classification, then a predefined location is set as the default attachment directory location for that file category or classification. Again, however, as shown in block 340, if the user does designate a customized directory location for an attachment file category, then that customized location is set as the attachment directory default location for that file category. For example, a user may choose to retrieve sound files from a directory named “My Sounds” where the user stores his or her favorite sound files. If this specified directory location has not yet been created, it will be created after it has been set as the default location.

Next in block 350, the user initiates a command, typically via a GUI, to add a file as an attachment to an electronic message that the user is composing. Typically, the user composes the electronic message on an electronic messaging client, such as Microsoft Outlook, Eudora, or an electronic messaging client provided by the user's ISP. Alternatively, the electronic messaging client may comprise an instant messaging client or some other electronic messaging system. In composing the message, a user typically has an electronic document open in a “Write” window upon which the user may type or enter a textual message into the body of the document. Users typically may get to the Write window by clicking “Write” (or similar button/link) on an electronic messaging client to compose a new email; selecting a received email message from the electronic messaging client inbox window and clicking “Reply” (or similar button/link); selecting a received email message from the electronic messaging inbox window and clicking “Forward” (or similar button/link); or clicking “Write” (or similar button/link) on an address book window to compose a new email. While accessing the electronic document in the Write window, for example, the user may execute a command to add a file as an attachment by pressing the appropriate button, icon, or link on the GUI of the attachment management system 101. Generally, then an “Attachment” window may be launched to facilitate the adding of attachments.

Next, as depicted in block 360, the user is prompted by the Attachment window, for example, to retrieve a file from one of his or her default attachment directory locations. Alternatively, the user may specify another directory location from which to retrieve a file for attachment purposes, as shown in blocks 362-365. For example, the user may manually enter a directory path and file name. In some embodiments, after the user has specified another directory location, the user will be provided the option of establishing this new directory location as the default directory location.

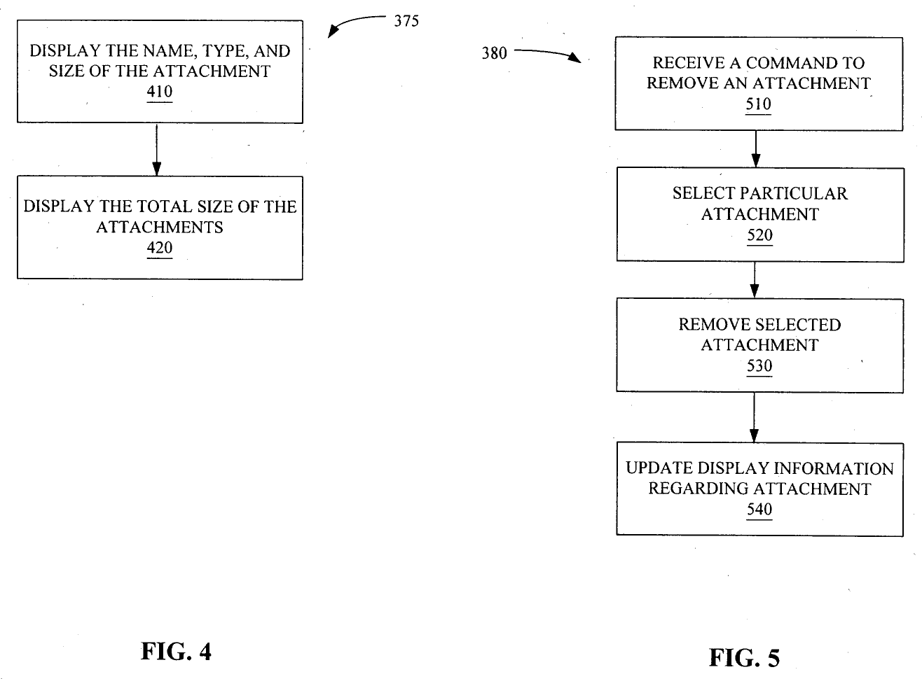

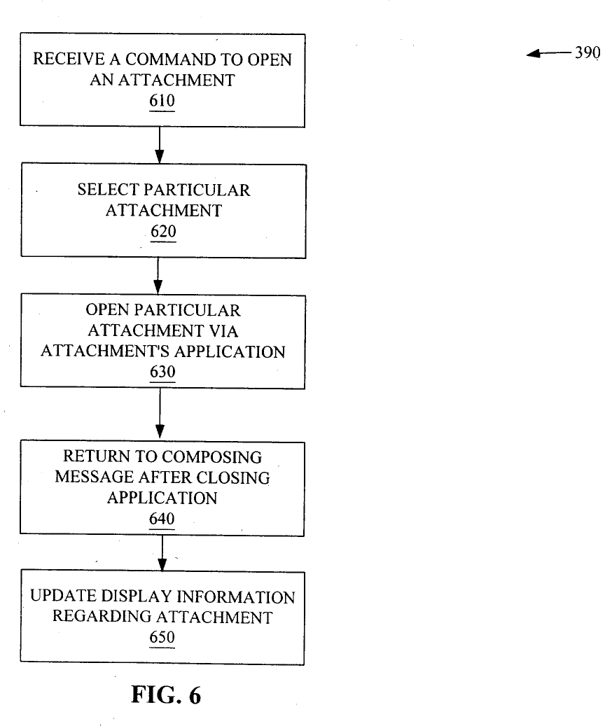

Once a file is designated by the user, as shown in block 370, the file is added as an attachment to the electronic message by the attachment management system 101 in cooperation with the electronic messaging client 115. Then, in block 375, information regarding the attached file or attachment is displayed along with the textual content of the electronic document. One preferred embodiment for displaying this information is shown in FIG. 4 and is described later in this document. In block 380 of FIG. 3, a removal process is represented for removing an attachment. This process is also described hereinafter at FIG. 5. Correspondingly, the editing process in block 390 is represented for opening and/or editing an attachment. Likewise, this process is described hereinafter at FIG. 6.

Typical examples of the information regarding the attached filed that may be displayed in the process of FIG. 4 include the name of the attached file, the type of the attached file, and the size of the attached file. The type of the file may be determined from the file type that is associated with the file name extension by the operating system. Accordingly, in block 410, after a file has been added as an attachment, the name of the attached file, the type of the attached file, and the size of the attached file are shown along with an icon representing the attachment. Typically, this information is shown at the bottom of a Write window below the message body or the information is shown in a separate Attachment window. Additionally, the total size of all the files that have been added as attachments to the electronic message being composed is displayed, as depicted in block 420. Typically, the total size of the attachments is displayed below the information from step 410 in the Write window or a separate Attachment window. For example, to display the attachment information in the Attachment window, the MIME header of an electronic message may be viewed and the attachments are counted and the number of attachments is presented to the user (e.g., “You have 4 files(s) attached”). The total size information is important to a user who has a slow connection to the Internet because large attachments will take a long time to transmit over the slow connection. Further, many Internet service providers (ISPs) limit the size of electronic messages that can be transmitted by their customers.

After a file has been added as an attachment, an attachment may later be removed. One preferred embodiment of this process is shown in FIG. 5. In block 510, a command from the user is received to remove an attachment that the user had previously added. Typically, this command is implemented using a GUI. In block 520, the user selects the particular attachment that the user wants removed. In a typical windows environment, the user may highlight the icon representing the attachment and then initiate the command for removing the attachment by pressing a “Remove Attachment” button, for example. Alternatively, the user may also press a “Remove Attachment” button and then select the particular attachment that is to be removed.

After the attachment is selected by the user, the attachment is removed from the electronic message by the attachment management system 101, as depicted in block 530. Next in block 540, the display information for the attachment(s) is updated after an attachment is removed. For example, the total size displayed for the attachments will be reduced to reflect the reduction in total size due to the removal of an attachment.

Referring now to FIG. 6, the process of opening or editing an attachment as shown in block 390 is discussed. In block 610, a command is received from a user, typically from a GUI, to open a particular attachment. In block 620, the user selects the particular attachment that the user wants opened. In a typical windows environment, the user may highlight the icon representing the attachment and then initiate the command for opening the attachment by pressing an “Open Attachment” button for example. Or, the user may press an “Open Attachment” button (or similar button/link) and then select the particular attachment that is to be removed. Alternatively, the user may be able to double click on the icon representing the attachment to initiate the opening of the attachment.

After the attachment is selected by the user, the attachment is opened or executed by the program that is associated with that file type according to predefined file associations in the operating system, as shown in block 630. Most file types have a designated default application or program to use when a file of that type is “opened.” The relationship between a file type and it's default program is called a “file association.”

If there is no association, then the user has to designate which application is needed to open the attachment. While the attachment is opened, the user may edit the attachment, depending on the attachment's type and its associated application. Then, after a user finishes editing an attachment, the user may close out of the attachment's application and return to the attachment management system 101, as shown in block 640. If edits made to the attachment while under control of the attachment's application were saved, then the edits are included in the attachment in the electronic message. After the user closes his or her application, the display information for the particular attachment is updated, and the display of the total size of the attachments is updated, as shown in block 650.

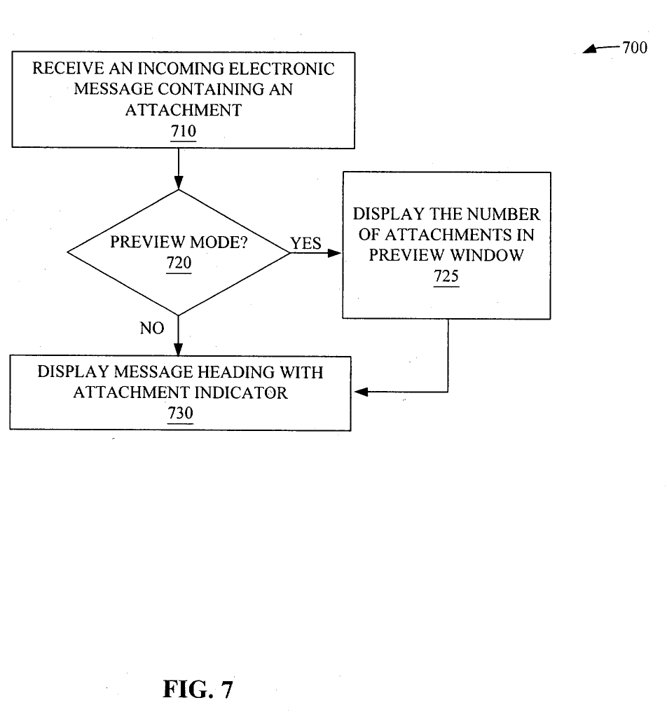

Referring to FIG. 7, the functionality of a representative embodiment of the attachment managing system 101 or method 700 for obtaining information regarding an attachment from an unopened electronic message may be construed as beginning at block 710. In block 710, an electronic message containing at least one attachment is received by a user's electronic messaging client. After the electronic message is received, descriptive information regarding the attachment(s) in the electronic message are displayed without the message being opened by a user. Generally, some email clients feature a “preview mode” that allows a user to see in a “Preview” window a small portion from the body of a received message without opening the email in its entirety. In accordance with a preferred embodiment of the present invention, if the electronic messaging client is in preview mode, as depicted in blocks 720-725, then the number of attachments contained in the message is shown in the Preview window. As shown in block 730, an icon or some other indicator is displayed next to the message heading display to show that the received message contains attachment(s).

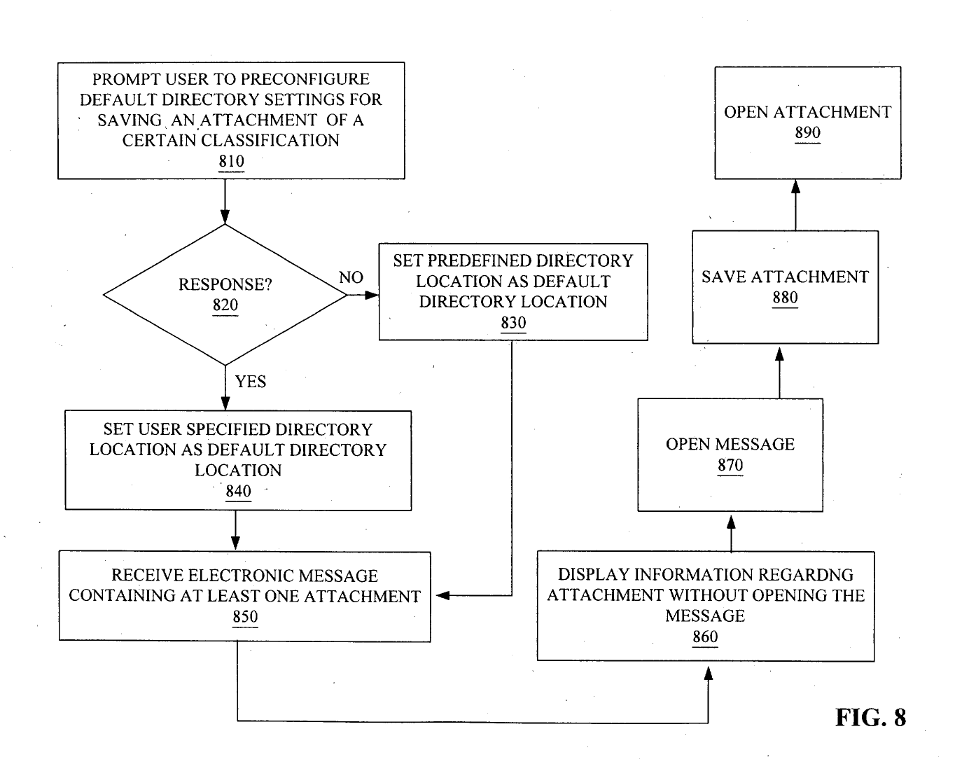

Referring to FIG. 8, the functionality 800 of one embodiment of the attachment management system 101 for viewing information regarding an attachment is described in greater detail. In this particular embodiment, one implementation for storing a copy of an attachment in accordance with the present invention is also discussed. First; in block 810, a user is prompted to preconfigure a default attachment directory location for saving a particular classification of attachment from an electronic message. For example, the user may specify default attachment directory locations for storing a “sound” file, an “image” file, or a “general” file type, such as a spreadsheet. Further, a user may be prompted to provide a default location for more than one type of file, such as one default attachment directory location for sound files and a different default directory location for image files. It is noted that these default directory locations may also be set up as the default directory locations for the processes represented by FIGS. 2-7, though not necessarily.

As depicted in block 820, the attachment management system 101 contemplates that a user may fail to respond and provide a default attachment directory location. Accordingly, in block 830, a predefined location is set as the default directory location for that file classification or category if the user does not provide a particular default attachment directory location. Again, however, as shown in block 840, if the user does provide a customized default directory location, then the customized location is configured as the default directory location for the corresponding file classification. For example, a user may choose to store image files to a directory named “Saved Image Files” where the user stores his or her favorite picture files.

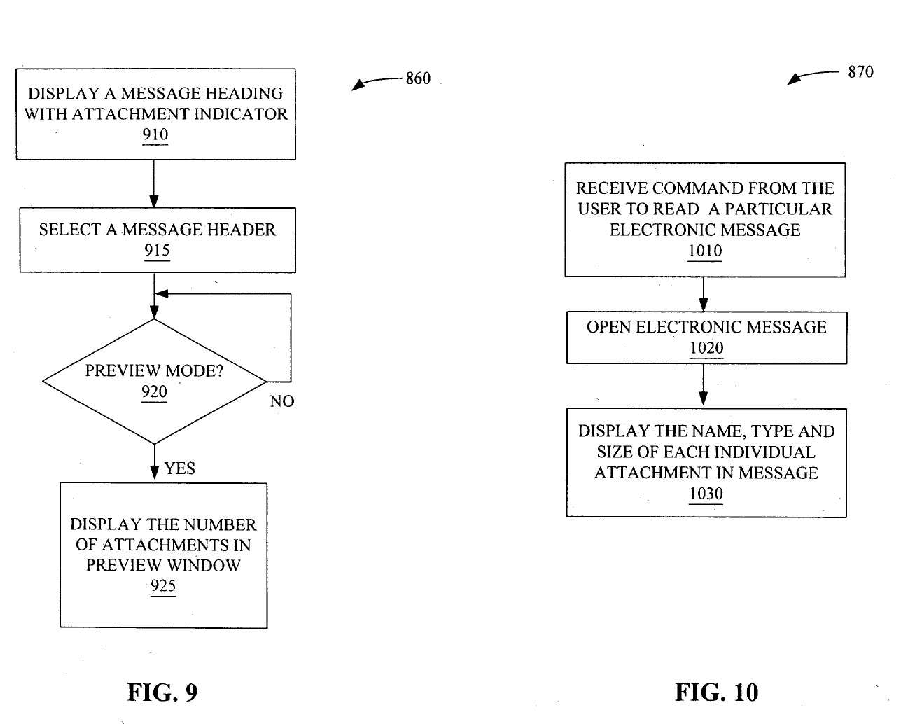

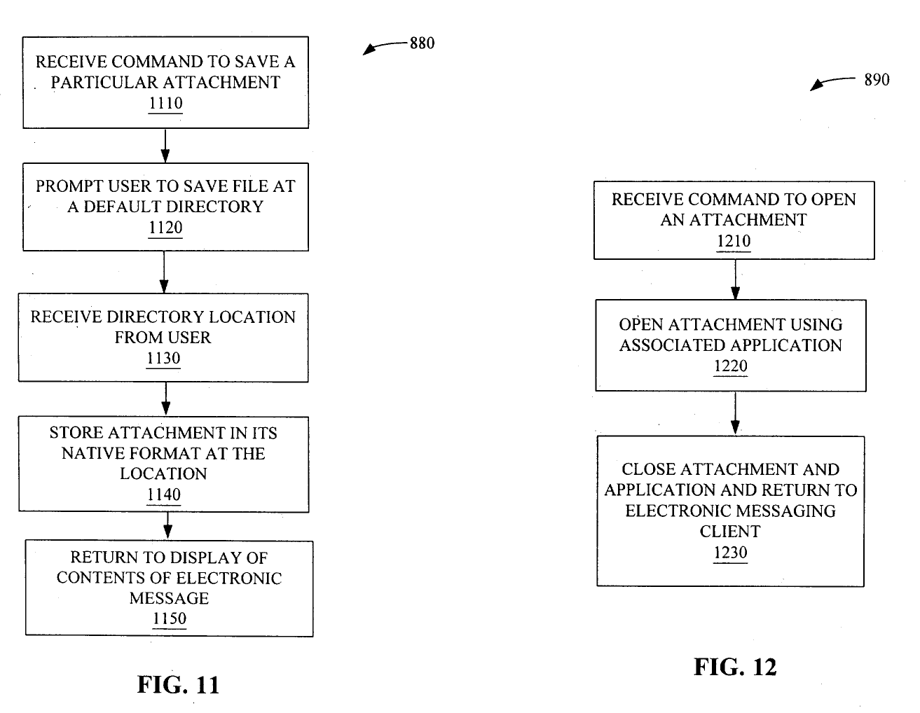

Next in block 850, an electronic message with at least one attachment is received. Of course, since the preconfiguration of directory locations may occur once during installation in some embodiments, block 850 will typically occur many times without following any preconfiguring steps. Generally, the electronic message is received on an electronic messaging system such as an email client, such as Microsoft Outlook, Eudora, etc. Alternatively, the electronic messaging client may comprise an instant messaging client. As depicted in block 860, the next step in the process is that information regarding the attachment(s) is displayed without opening the message. The details of this step are discussed hereinafter with regard to FIG. 9. The process of opening an attachment is represented by block 870 and is further discussed hereinafter in regard to FIG. 10. Correspondingly, the process of saving an attachment is represented by block 880 and is discussed below in regard to FIG. 11.

Referring now to FIG. 9, the process 860 of displaying information regarding an attachment of an unopened message for one preferred embodiment of the invention is shown. In block 910, after a message with at least one attachment is received, a message heading for that message is displayed with an attachment indicator. Typically, in the user's mailbox inbox, a message heading is shown that identifies the origin and/or subject of the electronic message along with an attachment indicator. The attachment indicator may be a small icon displayed next to a message heading indicating that attachments are enclosed in the electronic message. Next, in block 915, in response to a user input, the message heading of a particular electronic message is selected, perhaps by highlighting the heading using a computer mouse. As previously discussed, many email clients feature a “preview mode” that allows a user to see in a Preview window a small portion from the body of a received message without opening the email in its entirety. Accordingly, if the electronic messaging client is in preview mode, as depicted in blocks 920-925, then the number of attachments contained in the selected message is displayed in the Preview window for that message. In some embodiments, the number of attachments in the Preview window may be displayed as a link that may be activated by a user. Upon activation of the link, an Attachment window may be launched so that the user can access the attachments without opening the electronic message.

Referring now to FIG. 10, the process 870 of opening an electronic message and displaying information regarding the attachments therein for one preferred embodiment of the invention is depicted. In block 1010, a command to open an electronic message is received from the user, typically via a GUI. Generally, a user may open a particular electronic message by highlighting the corresponding message heading and then double clicking on the message heading or by clicking on a “Read” button (or similar button/link). After the command is received to open the message, the message is opened by generally displaying the full contents of the message body in a separate Read window, as depicted in block 1020. The read window is the central point from which users read, reply to, and forward email messages. This window provides controls that enable users to perform additional tasks, such as deleting a message, saving a message, and managing file attachments.

In block 1030, information regarding the attachment(s) in the electronic message is displayed. Typical examples of the information regarding the attachment that may be displayed include the name of the attachment, the type of the attachment, the size of the attachment, and an icon representing the attachment. The type of the file may be determined from the file type that is associated with the file name extension by the operating system. Typically, this display information is shown at the bottom of the Read window below the message body or the information is shown in a separate Attachment window. Additionally, the total size of all the files that have been added as attachments to the electronic message being composed may be displayed.

Referring now to FIG. 11, the process 880 of saving an electronic message to a directory location on a storage medium for one preferred embodiment of the invention is depicted. In block 1110, a command is received from the user to save a particular attachment, perhaps by highlighting an icon representing the representing the attachment in the message body and pressing a button labeled “Save Attachment.”

After the command is received, the user is prompted to save the copy of the attachment to one of his or her default locations where the user's favorite files are presumed to be located, as depicted in block 1120. For example, a user may click on one of the predefined location buttons to go directly to the user's local directories for storing specific file types to select a file. These buttons are mapped accordingly. Once the user is taken to their default directory, the user may browse freely in Explorer mode to locate other files. Alternatively, the user may specify another location to store a copy of the attachment to or drag the icon representing the attached file into a desired directory on the local machine.

Once a location is designated by the user, as shown in block 1130, a copy of the attachment is stored at the designated location in its native file structure, as depicted in block 1140. To do so, the copy of the attachment is restored to its original format by the electronic messaging program before it is saved or stored at the default directory location. After the copy is saved, the user is returned to the display of the contents of the electronic message, such as a Read window, as shown in block 1150.

Referring now to FIG. 12, the process 890 of opening an electronic message and displaying information regarding the attachments therein for one preferred embodiment of the invention is depicted. In block 1210, a command is received from the user to open an attachment, perhaps by highlighting an icon representing the attachment in the message body and pressing a button labeled “Attachment” (or similar button/link) or by double clicking on the particular icon representing a particular attachment. Accordingly, the attachment is opened or executed by the program that is associated with that file type according to predefined file associations in the operating system, as shown in block 1220. If there is no association, then the user may designate which application is needed to open the attachment. After the user finishes accessing the contents of the attachment, the user may close out of the attachment's application and return to the attachment management system, as shown in block 1230.

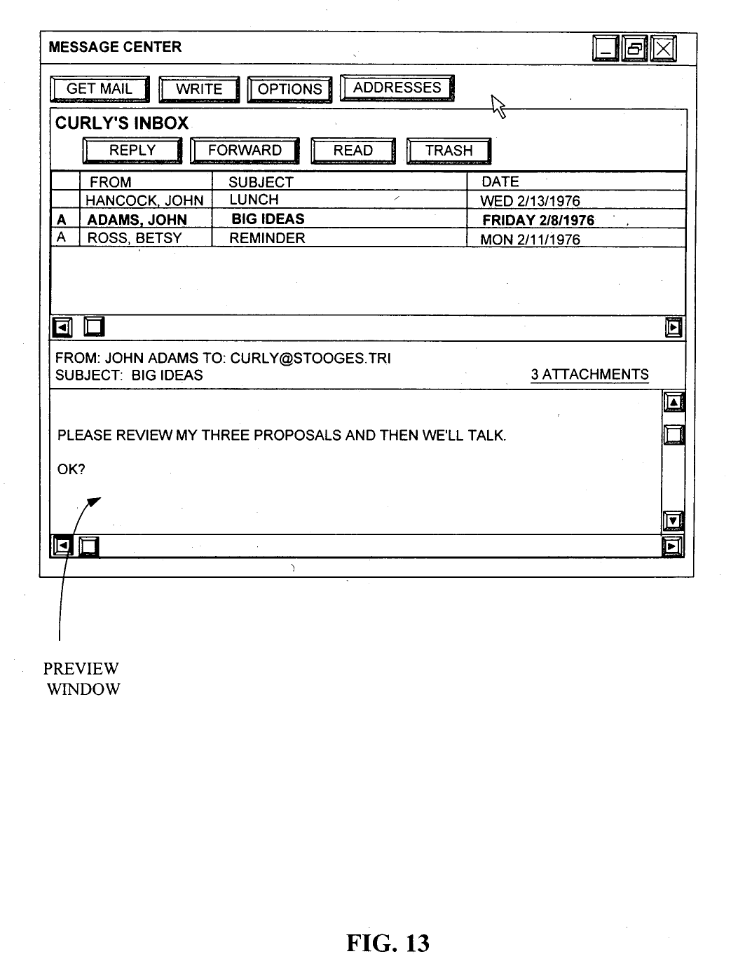

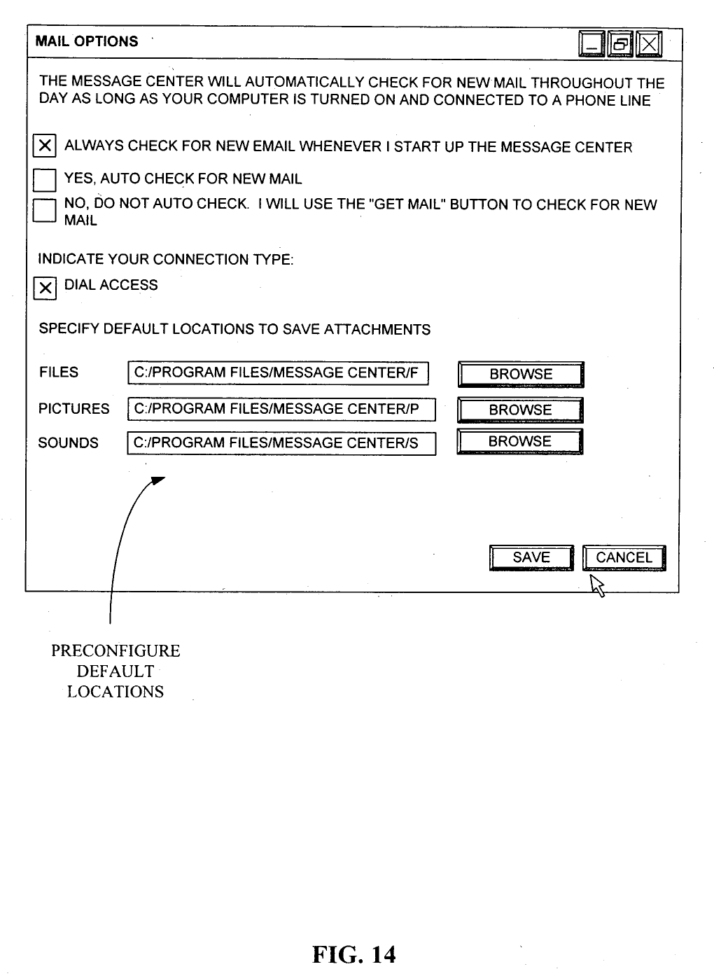

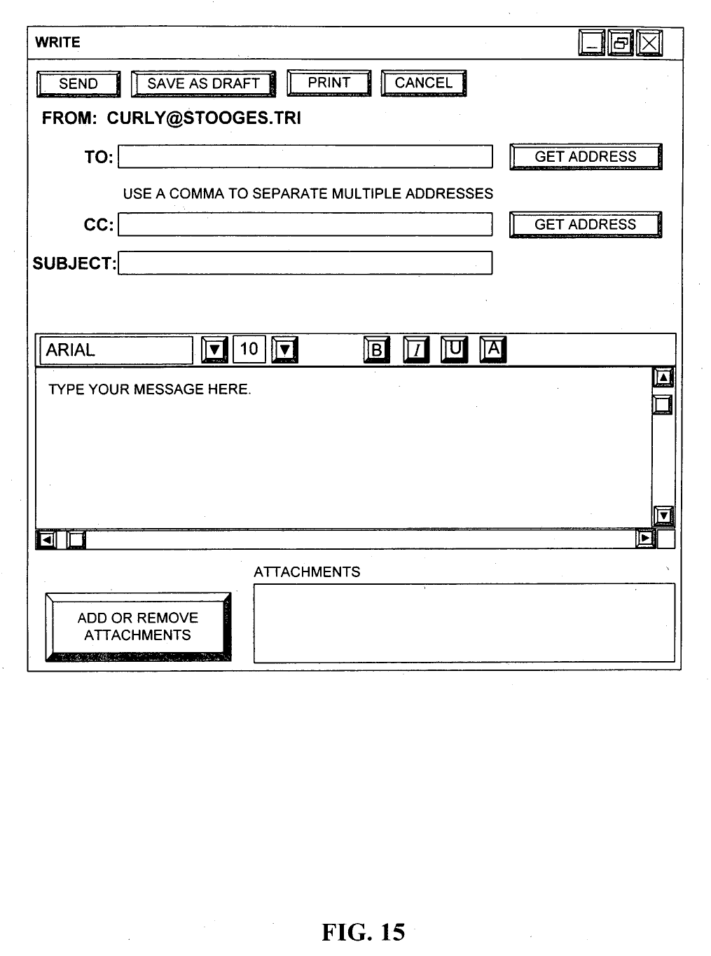

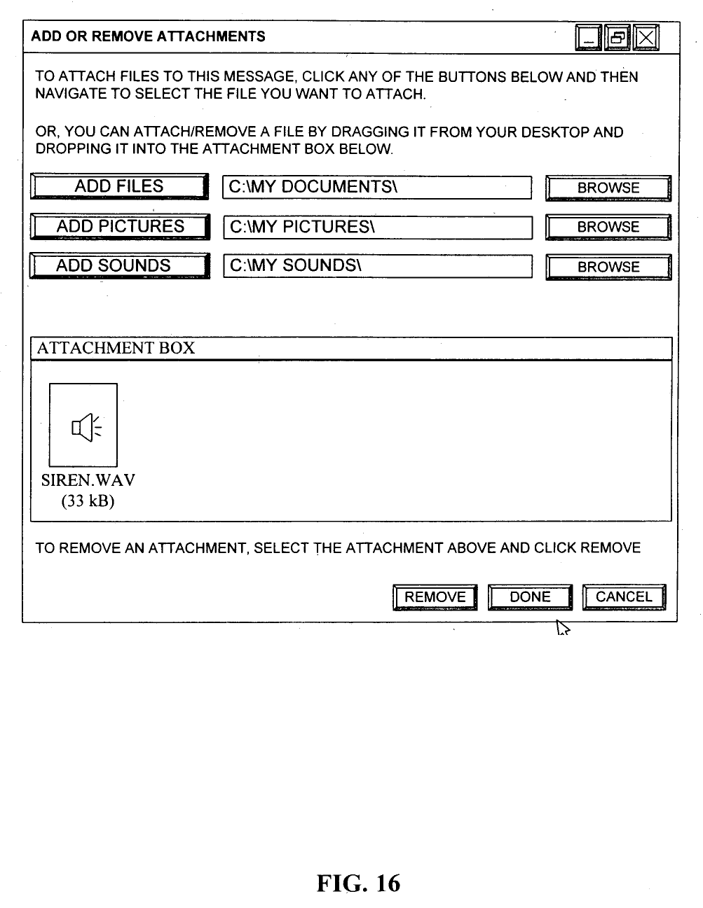

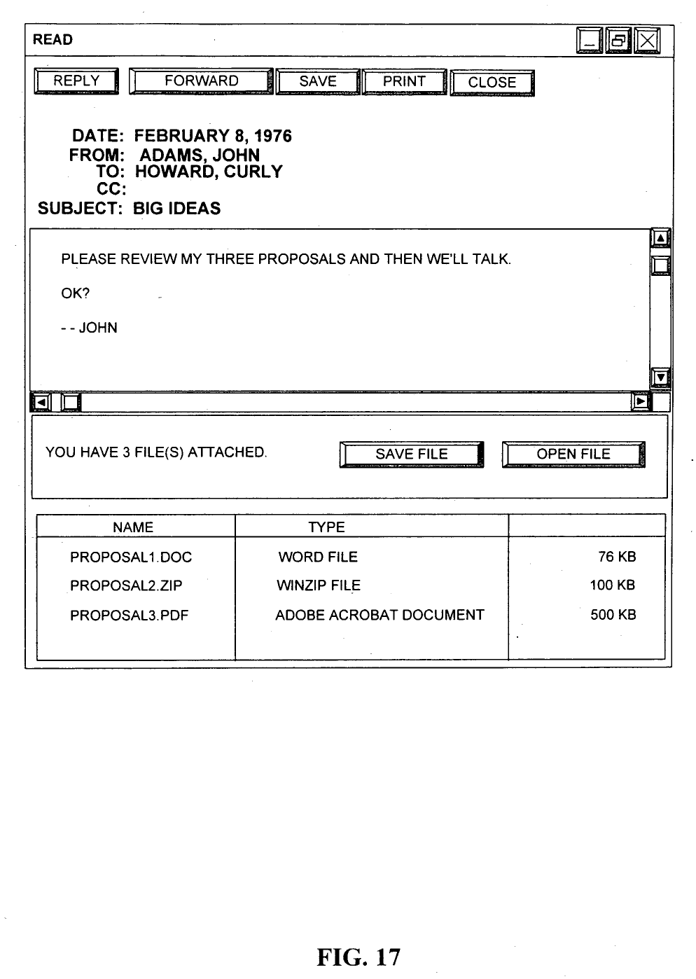

As previously stated, many of the steps shown in the preceding flowcharts may be facilitated by the use of a GUI. Accordingly, FIG. 13 shows one preferred embodiment of a user's inbox in “preview mode” that may be utilized to facilitate the steps in FIGS. 3, 7, and 9. Also, FIG. 14 depicts one preferred embodiment of an “Options” window that may be used facilitate steps in the flowchart of FIG. 2. FIG. 15 depicts one representation of a “write window” which may be used to facilitate the steps in the flowcharts of FIGS. 3-4, as previously described, and FIG. 16 depicts an “Attachment” window as described with regard to the flowcharts for FIGS. 3,4,9, and 10. To facilitate many of the steps in FIGS. 10-11, a “Read” window, may be utilized as depicted in FIG. 17 for one preferred representation.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Advantageously, the above-described embodiments of the present invention, intuitively manages attachments that a user adds to or receives from electronic messages. Accordingly, users are more able to easily understand how to operate their electronic messaging clients which reduces the amount of technical support that is needed to be supplied by an electronic messaging provider to its customers. It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the principles of the invention. All such modifications and variations are intended to be included herein within the scope of this disclosure and the present invention and protected by the following claims.

Therefore, having thus described the invention, at least the following is claimed:

1. A method for managing attachments in electronic messages comprising:
preorganizing a default directory location for storing a particular classification of attachments;
receiving an electronic message having an attachment; and
storing the attachment in a default directory location according to the classification of the attachment.

2. The method claim 1, the preorganizing step further comprising:
prompting a user to specify a customized directory location for storing attachments of a particular classification;
receiving the customized directory location from the user; and
setting the customized directory location as the default directory location.

3. The method of claim 1, the preorganizing step further comprising:
prompting a user to specify a customized directory location for storing attachments of a particular classification;
failing to receive a customized directory location from the user; and
setting a predefined directory location as the default directory location.

4. The method of claim 1, wherein more than one default directory is preorganized.

5. The method of claim 1, further comprising:
displaying descriptive information regarding the attachment.

6. A method for adding an attachment to an electronic message comprising:
composing an electronic message;
adding an electronic file as an attachment to the electronic message; and
displaying descriptive information regarding the attachment.

7. The method of claim 6, the displaying step comprising:
displaying the name of the electronic file; and
displaying the size of the electronic file.

8. The method of claim 7, further comprising:
displaying the file type of the electronic file.

9. The method of claim 8, further comprising:
displaying the total size of all the attachments that have been added to the electronic message.

10. The method of claim 6, wherein the descriptive information is viewable while a user composes the electronic message.

11. The method of claim 6, further comprising:
removing the attachment.

12. A method for displaying descriptive information regarding an attachment, comprising:
receiving an electronic message having at least one attachment; and
displaying the number of attachments in the message without opening the message.

13. The method of claim 12, further comprising:
opening the message;
and displaying the name, size, and type of an electronic file that constitutes the attachment.

14. The method of claim 13, further comprising:
displaying the total size of all the attachments contained in the electronic message.

15. A computer readable medium having a computer program for managing attachments in electronic messages, the program for comprising the steps of:
preorganizing a default directory location for storing a particular classification of attachments;
receiving an electronic message having an attachment; and
storing the attachment in a default directory location according to the classification of the attachment.

16. The medium of claim 15, the preorganizing step further comprising:
prompting a user to specify a customized directory location for storing attachments of a particular classification;
receiving the customized directory location from the user; and
setting the customized directory location as the default directory location.

17. The medium of claim 15, the preorganizing step further comprising:
prompting a user to specify a customized directory location for storing attachments of a particular classification;
failing to receive a customized directory location from the user; and
setting a predefined directory location as the default directory location.

18. The medium of claim 15, wherein more than one default directory is preorganized.

19. The medium of claim 15, the program further comprising the step of:
displaying information regarding the attachment.

20. A computer readable medium having a computer program for adding an attachment to an electronic message, the program for comprising the steps of:
composing an electronic message;
adding an electronic file as an attachment to the electronic message; and
displaying descriptive information regarding the attachment.

21. The medium of claim 20, the displaying step comprising:
displaying the name of the electronic file; and
displaying the size of the electronic file.

22. The medium of claim 21, the program further comprising the step:
displaying the file type of the electronic file.

23. The medium of claim 21, the program further comprising the step:
displaying the total size of all the attachments that have been added to the electronic message.

24. The medium of claim 20, wherein the descriptive information is viewable while a user composes the electronic message.

25. The medium of claim 20, the program further comprising the step of:
removing the attachment.

26. A computer readable medium having a computer program for displaying descriptive information regarding an attachment, the program comprising the steps of:
receiving an electronic message having at least one attachment; and

27. The medium of claim 26, the program further comprising the steps of:
opening the message;
and displaying the name, size, and type of an electronic file that constitutes the attachment.

28. The medium of claim 27, the program further comprising the step of:
displaying the total size of all the attachments contained in the electronic message.

29. A system for managing attachments in electronic messages comprising:
an electronic messaging client for receiving an electronic message having an attachment; and
an attachment managing system configured to:
preorganize a default directory location for storing a particular classification of attachments; and
store the attachment in a default directory location according to the classification of the attachment.

30. The system of claim 29, the attachment management system further configured to:
prompt a user to specify a customized directory location for storing attachments of a particular classification;
receive the customized directory location from the user; and
set the customized directory location as the default directory location.

31. The system of claim 29, the attachment management system further configured to:
prompt a user to specify a customized directory location for storing attachments of a particular classification; and
set a predefined directory location as the default directory location after failing to receive a customized directory location from the user.

32. The system of claim 29, wherein more than one default directory is preorganized.

33. A system for adding an attachment to an electronic message comprising:
an electronic messaging client for composing an electronic message; and
an attachment management system configured to:
add an electronic file as an attachment to the electronic message; and
display descriptive information regarding the attachment.

34. The system of claim 33, wherein the display descriptive information comprises:
displaying the name of the electronic file; and
displaying the size of the electronic file.

35. The system of claim 34, the attachment management system further configured to display the file type of the electronic file.

36. The system of claim 34, the attachment management system further configured to display the total size of all the attachments that have been added to the electronic message.

37. The system of claim 33, wherein the descriptive information is viewable while a user composes the electronic message.

38. The system of claim 33, wherein the attachment management system is further configured to remove the attachment.

39. A system for displaying descriptive information regarding an attachment, comprising:
an electronic messaging client for receiving an electronic message having at least one attachment; and
an attachment management system for displaying the number of attachments in the message without opening the message.

40. The system of claim 39, the attachment management system further configured to display the name, size, and type of an electronic file that constitutes the attachment after the electronic message is opened.

41. The method of claim 40, the attachment management system further configured to display the total size of all the attachments contained in the electronic message.
